(19) United States
(12) Patent Application Publication
(10) Pub. No.: US 2001/0039514 A1
(43) Pub. Date: Nov. 8, 2001

(54) System and method for managing excess capacity for events of natural expiration via wireless devices

(76) Inventors: Rachel L. Barenbaum, New York, NY (US); Anne P. Bergman, New York, NY (US)

Correspondence Address: James G. Gatto, Esq., Hunton & Williams, Suite 1200, 1900 K Street, N.W., Washington, DC, 20006, US

(21) Appl. No.: 09/824,744

(22) Filed: Apr. 4, 2001

Related U.S. Application Data
(60) Provisional application No. 60/194,484, filed on Apr. 4, 2000.

(51) Int. Cl. G06F 17/60

(52) U.S. Cl. 705/14; 705/1

(57) ABSTRACT

A system and method of the present invention manages excess capacity for events that have a natural expiration and/or other products and services, where users may be notified of a time sensitive digital deal via a wireless device. Digital deals may be conveyed by the system based on user profile (and/or other) data or may be prompted by user initiation. A client may inform the server of the present invention of the available of a resource (e.g., available seats) for a time sensitive event. The server may process this information and alert potential users via a text message on a wireless device. In addition, a user may request digital deals from the server based on advertisement or other user prompt. The server may provide the requested digital deal to the user via wireless communication in the form of a text message or voice message. The system may convey a visual display associated with a digital deal to the user's wireless device that may be shown to a point-of-sale entity for redemption.

### CROSS REFERENCE TO RELATED APPLICATIONS

This application claims priority from provisional application Ser. No. 60/194,484, filed Apr. 4, 2000, which is incorporated by reference.

### FIELD OF INVENTION

The present invention relates generally to the field of capacity management, in particular to a system and method for managing excess capacity for events that have a natural expiration and/or other products and services, where users may be notified of a time sensitive digital deal, which may be prompted by user profile (and/or other) data or user initiation, via a wireless device.

### BACKGROUND OF THE INVENTION

A number of companies have attempted to improve capacity management for time sensitive or scheduled and recurring activities, such as movies, concerts and other events. Time sensitive activities generally include events with a limited number of resources (e.g., seats in a stadium or movie theater) that expire naturally with the occurrence of the event itself.

In the past, companies have used incentives to lure customers to purchase time-sensitive products or services to offset over capacity. Recently, companies have attempted Internet-based solutions. For instance, generally, retailers and other providers have attempted online distribution of incentives to potential customers for the purchase of selected products and services. However, this has not been as effective when dealing with time-sensitive scenarios with finite capacity or inventory. Because of the time sensitive nature of the events or offers, potential users are difficult to locate and notify promptly. An email notification may not be the most effective way to notify mobile users of time sensitive discount information for events in the immediate future. In addition, potential users may not have access to the Internet a few hours before the start of a show, for example.

Users are generally required to visit web-sites to download and print hard copies of incentive certificates for redemption at the point-of-sale. However, various security and fraud issues have been associated with such marketing tactics. For example, fraudulent users can easily photocopy a single printed coupon or print multiple copies of a single coupon for unauthorized repeated use. Complexities and security problems exist in current systems for managing excess capacity.

These and other drawbacks exist with current systems.

### SUMMARY OF THE INVENTION

The present invention provides a method and system for identifying and managing excess capacity for events of natural expiration whereby potential users are notified by wireless communication. The systems and methods of the present invention utilize capacity utilization and yield management techniques to enhance sales and profits. Digital deals may include client provided incentives to attract potential users to purchase identified resources. Digital deals may be based on user profile (and other data) or prompted by user initiation. A client may inform the server of the present invention of the availability of a resource (e.g., available seats, perishable goods, end of the season inventory, etc.) for a time sensitive event. The server may process this information and alert potential users via a text (or voice/audio) message or other type of message on a wireless device. In addition, a user may request digital deals from the server based on an advertisement or other user prompt. The server may provide the requested digital deal to the user via wireless communication in the form of a text message, voice message or other type of message. The system may convey a visual display associated with a digital deal to the user's wireless device that may be shown to a point-of-sale entity for redemption. According to one embodiment, the user need not print a coupon or other certificate to partake in the digital deal.

Additional advantages of the invention will be set forth in part in the description which follows, and in part will be understood from the description, or may be learned by practice of the invention. The objects and advantages of the invention may be realized and attained by means of the instrumentalities and combinations particularly pointed out in the appended claims.

One embodiment of a method of the present invention reduces excess capacity for an event having a predetermined capacity and a natural expiration. The method comprises the following steps: identifying an event that is likely to have excess capacity at the time of expiration; creating a digital deal relating to the event to stimulate demand for the event and reduce excess capacity; communicating the digital deal to one or more consumers via wireless communication; and enabling the one or more users to partake in the digital deal without generating a printed coupon. The method may further comprise the step of communicating the digital deal to a wireless promotions server system prior to communicating the digital deal to a consumer, wherein the step of communicating the digital deal to the consumer is performed by the wireless promotions server system. The step of creating a digital deal may further comprise using a stored template, the template comprising a plurality of fields and the step of creating a digital deal may further comprise entering values for the fields. The following additional features may be incorporated in the method: the consumer is a registered user of the wireless promotions server system; the wireless communication comprises a text message; the wireless communication comprises a voice message; the event comprises an entertainment event; the predetermined capacity comprises a limited number of available seats; the natural expiration substantially coincides with the performance of the event; and the step of communicating the time sensitive digital deal comprises the step of conveying a visual display wherein the visual display authorizes the user to receive the digital deal.

In another embodiment, a method of the present invention enables digital deals via two-way text messaging via wireless devices. The inventive method includes the following the steps: creating a digital deal; displaying information regarding the existence of the deal and contact information regarding the deal; a consumer creating a first message (e.g., text, voice or other) via a wireless device and sending the message to a system associated with the contact information; at the system, receiving the message, processing the message and sending a second message (e.g., text, voice or other) back to the consumer's wireless device with information about how to partake in the digital deal; and the consumer using the second message to partake in the digital deal without generating a printed coupon. In the inventive method, the step of a consumer creating a message (e.g., text, voice, or other) may further comprise the steps of a consumer identifying the consumer's wireless device address information and wireless service provider and referencing a digital deal code associated with the displayed information.

In another embodiment, a system of the present invention enables a client to reduce excess capacity via wireless devices. The system includes: a wireless promotions server system; a module for creating digital deals and transmitting the digital deal information to the wireless promotions server system; and wireless communication system for communicating the digital deal from the wireless promotions server system to one or more consumers via wireless communication to enable the consumer to partake in the digital deal without generating a printed coupon. The system may further include the following features: the wireless communication comprises a message (e.g., text, voice or other); the digital deal relates to an event, the event having a predetermined capacity and a natural expiration; the system conveys a visual display to the wireless device wherein the visual display authorizes the user to receive the digital deal; creating and storing profile data associated with a user; an analysis module responsive to the wireless promotions server system, for receiving one or more digital deals, for comparing deal information with user profile data and selectively transmitting the digital deal to one or more consumers based on their profile data; and ability for consumers to input profile data via a wireless device. The wireless device may be any wireless device including a phone, PDA, pager or combination of these and other devices and functionalities.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a schematic diagram of an overall system for managing excess capacity, according to an embodiment of the present invention.

FIG. 2 is a flowchart illustrating a method for enabling a client to manage excess capacity, according to an embodiment of the present invention.

FIG. 3 is a flowchart illustrating a method enabling a user to receive time sensitive digital deals, according to an embodiment of the present invention.

FIG. 4 is a flowchart illustrating a method enabling a user to engage in two-way messaging for digital deals, according to an embodiment of the present invention.

FIG. 5 is a schematic diagram of a centralized deal management system, according to an embodiment of the present invention.

### DETAILED DESCRIPTION OF THE PREFERRED EMBODIMENTS

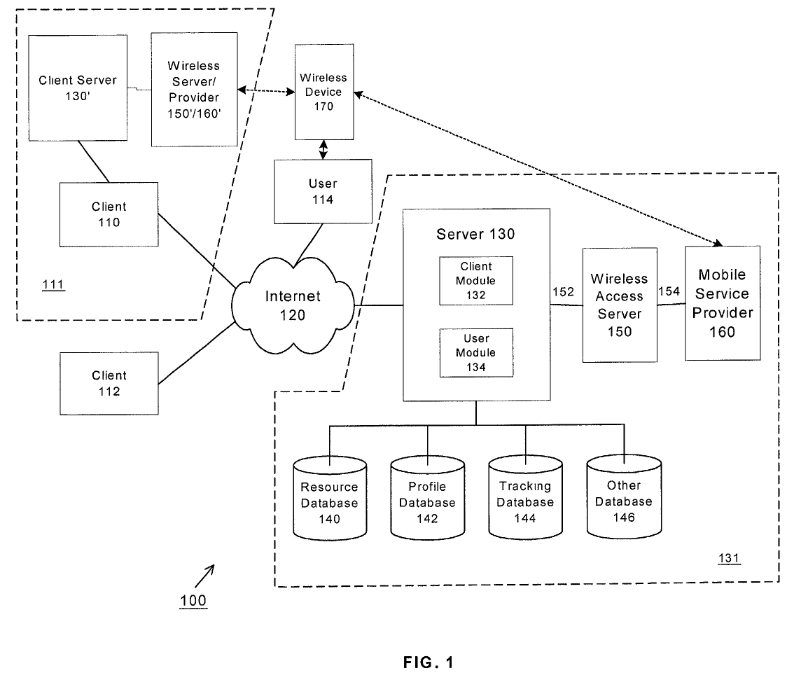

Referring generally to FIG. 1, the present invention provides a system and method for alerting potential customers of the availability of digital deals for events, services or products of predetermined capacity and/or natural expiration, referred to generally at 100. The present invention enables clients, such as service or product providers, to effectively and efficiently manage excess, unfulfilled capacity by inducing purchaser or consumer response to satisfy the excess capacity, such as by offering incentives to purchase unused seats or perishable goods, for example. Target markets may include movie theatres/studios, sports teams, live entertainment venues and other events that naturally expire with the occurrence of the event itself or goods or services that would go un-purchased with the closing of a retail outlet, e.g., video rentals. Other examples may include flights, cruises and other activities that are time sensitive. This could also include a service or good that has a series of time-sensitive availability due to such things as the regular operating hours of a retail outlet. For example, a grocery may have an over-stocked inventory of strawberries that are ripe and will be worthless in a few days. A bar may be experiencing a slow night and may create an event to fill up the bar's capacity and generate more revenue. A women's clothing store may be approaching the end of the summer season with an abundant supply of summer dresses and sandals.

Methods for alerting potential customers may include wireless communication, such as cell phones, PDAs, pagers, notebooks, e-tablets, vehicle on-board devices, and other mobile devices, and combinations of these and other devices and/or functionalities generically referenced at 170. According to one embodiment of the present invention, potential customers or users 114 may be alerted via text, audio or other messaging over a wireless network provider 160 via an access device 170. This feature of the present invention enables potential customers 114 to be notified when a client (or service/product provider on behalf of a client) 110-112 offers incentives (digital deals) to potential customers to purchase or fill excess capacity of a limited resource (e.g., seats in a concert, perishable goods, over-stocked merchandise, etc.). Utilizing the wireless access environment to provide incentives, alert and induce action in potential users addresses the time sensitive nature of both the incentive and the subject of the incentive. For instance, events, such as concerts, generally have a predetermined start and/or end time and the incentive becomes obsolete after the start or end time or at some point therebetween, as determined by the client or service provider. Thus, it is important for potential users to make the selected transaction within the relevant, active event time period and before the beginning of the event. Otherwise, the extra seats are wasted and revenues are lost due to unfilled excess capacity and/or wasted resources.

In another example, a client may provide additional incentives for ancillary sales of products (or services), such as refreshments, souvenirs, etc. For example, a movie theater may provide digital deals for all or selected Thursday night features. In addition, the movie theater may offer free popcorn as an additional incentive. In another example, a client may provide digital deals directed to non-time sensitive events, such as a premiere showing of a film, the introduction of a new product and other events. For example, a car dealer may provide a digital deal to introduce a new model of cars to potential users. In addition, a movie theater may provide free drinks to the first twenty ticket purchasers for the premiere showing of a new movie.

According to one embodiment of the present invention, a client or service provider, such as via server 130, monitors the inventory or capacity of its goods, service or resource and, based upon predetermined criteria, identifies an over or excess capacity condition. The client may then determine (for example on a graduated basis) one or more or a series of incentives, possibly based on some historical analysis (tracking database 144), necessary to induce purchase by customers to fill (or purchase) as much of the excess capacity (or over-stocked resources) as possible. The client, directly or via a service provider, then identifies a group of potential customers, such as by examining customer profile data stored in a database 142, and communicates in a wireless fashion the digital deals or incentives to the identified group of potential customers. The potential users are thereby alerted to the availability of a digital deal for a time sensitive event via text, voice or other messaging over a wireless access device.

The contacted users may then act on the digital deal and purchase the good or service within the action period, i.e., from time of notification through natural expiration of event or product. The “natural” expiration of an event may substantially correspond to the start or end point of the event, or some point therebetween. This term broadly refers to some identifiable condition of the event and may refer to a contrived expiration determined, for example, by a client or service provider based at least in part on the actual expiration of the event. Without the wireless delivery of the present invention, mobile users not having easy (or constant) access to the Internet at critical times may miss the window of opportunity or action period and the chance to act on the offered incentive and fill the client's excess capacity.

In this manner, a mobile user receives notification and information about a digital deal without having to access the Internet or to visit the web site of a sponsor, such as via a desktop or small handheld device. However, in conjunction with the wireless communication aspects of the invention, a traditional web site may display offers and provide email or other alerts to a user. For example, at the present web sites are generally difficult to navigate and view on wireless access devices, many of which are limited physically by a small screen and lack of navigation options. In addition, the current bandwidth availability may limit the display of information on wireless access devices. Based on previously gathered profile data from a user (and/or other sources), the present invention may provide text, voice or other messaging of upcoming time sensitive events, via wireless communication to enable a user to be notified anytime, anywhere (within a service area) of events that may occur in the immediate future, especially events or event types previously identified as potentially of interest to the customer. Further, as constant Internet connectivity evolves to provide constant notification, the present invention may also be implemented to receive and send messages via Internet as well.

Also, a client may determine a series of potential incentives or digital deals to offer to users in a progressive fashion. For instance, as the natural expiration draws nearer, the value or savings of each successive incentive may increase in value until enough users act on the incentive to satisfy the excess capacity. Or, the incentive may be communicated to more or additional groups of users. The service could also offer the user with the option of choosing a later or alternative date or event, good, or service. If the excess capacity situation is resolved after the first in a series of possible incentives, then the successive incentives would not be to offered or distributed. Historical and trend data can be stored in a database 144 and used by the client or service to help arrive at more and more effective and efficient incentive strategies.

According to another embodiment of the present invention, a potential user may initiate a request for digital deal information from a system of the present invention. A potential user may inquire about potential digital deals using a wireless device associated with a particular service or product by contacting the system of the present invention and entering content data (e.g., a code). The system may then respond to the user's inquiry and provide the requested digital deal information which may then be presented to an authorized entity, such as a retailer or other point-of-sale entity. The communication may be accomplished via wireless communication, which may further include text messaging and/or wireless voice communication.

According to another embodiment of the present invention, a visual display (e.g., an icon or logo) may be conveyed to a user's wireless device for access and viewing, and to authenticate redemption at the point-of-sale. This feature of the present invention eliminates the need to provide a print out of a hard copy of the incentive. Another added benefit of this is that fraudulent printouts or copies may be eliminated. Moreover, for events of natural expiration there is less of a concern for fraudulent printouts of digital deals, as the provider's ultimate goal is to find purchasers for a limited and expiring resource (e.g., seats in a stadium). The digital deal does not, necessarily, guarantee a seat or availability of the subject being offered, although this could be offered by the client or service provider within the context of the present invention. Therefore, the provider is not concerned if more deals are conveyed to potential users than the number authorized or available.

According to another embodiment of the present invention, a user may show a visual display on the user's wireless device (e.g., the screen of a cell phone) to a point-of-sale entity for redemption of the digital deal. In addition, the potential user may receive a code, password or other authorization identifier to present to the point-of-sale entity to engage in the digital deal. Thus, a user may simply notify the point-of-sale entity of a password (or other code) at the time of purchase. Again, printouts may be eliminated.

According to another embodiment of the present invention, the user may accept the digital deal on the user's wireless device. This feature of the present invention may automatically reserve and/or purchase an identified number of seats (or other resources, products, and/or services) through the wireless device. The transaction may be accomplished by a user entering transaction data (and other inputs) at the time of the transaction, based on user profile data (e.g., credit card information) or other combination. Thus, when the user reaches the associated venue, the user may provide identification information to confirm the user's reservation previously made using the digital deal. In all instances where the user visually presents the offer by the display of the mobile device 170, a client or service provider logo or the like may be included in the presentation display to give further evidence that the incentive displayed was properly issued by the client or service provider and received by the user.

Now referring specifically to the embodiment of FIG. 1, an overall system 100 for managing excess capacity enables entities, such as clients, 110, 112 and users 114, to access Server 130 of wireless promotions services system 131 through a distributed network, such as Internet 120, or other mode of communication. Server 130 includes Client Module 132, User Module 134 and may include other modules to effect the features described herein. In addition or in the alternative, localized or dedicated client system 111 may include a Client Server 130′ dedicated to a particular client. In addition, a separate dedicated access to a wireless server/provider 150′/160′ may be provided at the local client level to facilitate direct communication with users 114 via wireless devices 170. Wireless promotions services system 131 includes databases, such as Resource Database 140, Profile Database 142, Tracking Database 144 and other database 146. Server 130 may communicate to one or more potential users though Wireless Access Server 150, which communicates to Wireless Device 170 through a Mobile Server Provider 160. Communication links 152 and 154 may include Internet connections from Server 130 to Wireless Access Server 150 and Mobile Service Provider 160. While system 131 may illustrate a single system, each element of system 131 may also be implemented separately and/or independently.

One or more clients, 110, 112 may access one or more Server(s) 130, 130′ to create, enable and issue digital deals and other incentives for time sensitive and other events. Server 130 may provide a back-end capacity management resource, built and customized specifically for wireless platforms. The present invention may connect entertainment and service providers to front-end wireless/wired sites (e.g., content providers) through the service of real-time digital deals, management systems, payment capabilities and/or other services.

For example, clients 110, 112 may access Server 130, which may be operated by an intermediary such as a wireless promotions service provider, to place an interface on a central server site or on client sites inviting potential users to sign up and receive digital deals via Internet 120 or other mode of communication. Clients 110, 112 may access client module 132 to specify the availability of resources for one or more identified events of natural expiration. For example, a client may provide Server 130 with one or more of resource data (e.g., 100 seats for a baseball game are empty), time data (e.g., start time of the game, time left until the start time), reduced price data ($5.00 per ticket), restriction data and other information. Such data may be stored in Resource Database 140, for example.

According to another embodiment of the present invention, client server 130′ may be implemented. Client server 130′ may be dedicated to a client, such as 110, and further comprise some or all the functionality provided by server 130. A potential user 114 may access client server 130′ through client 110 via an Internet connection to specify and retrieve digital deals of particular interest to the user.

The system 100 may include a reservation system that allows for the reservation of virtually any resource, without prior knowledge of which web site specifically handles reservations for that resource. The reservation system consists of a resource database that includes a list of reservable resources, such as hotels, restaurants, or sports facilities. Along with each listing is a link to a wireless/wired web site that directly handles reservations on behalf of the resource. The system 100 includes an engine capable of accessing existing reservation systems, and when the user makes a reservation request (by clicking on a reservation incentive) for a resource, the following steps will occur. First, the system 100 searches the database 140 to find the reservation system for that resource. Second, the system inquires into whether the date/time requested is available. Third, the system communicates with the user by either letting them know that the resource is booked and the reservation was unable to be made or that the reservation is complete. The system 100 resource search engine allows for fast searches of the resource database. Clients can link to the resource engine, thereby “reservation enabling” the client site. The resource search engine accepts search criteria and returns matching results. Each result is a link to the system transaction server, which brokers the transaction between the user and the site directly handling the reservation. The system 100 has the ability to make the reservation instantly using an extensive database of information on users. Simply clicking on the reserve button will allow the system 100 to access the users' name, credit card, special travel deal access (miles rewards programs, frequent flier programs) and all other relevant information needed to make the reservation.

As an initial matter, user 114 may access Server 130 to register with the system of the wireless promotions service or function. A user may provide profile data at User Module 134 to enable the user to be informed of digital deals that are of interest to the user. Profile data may include preference data, contact data, location data, and demographic and other data. For example, the user may specify interest in concerts of a particular music category (e.g., rock, R&B, Country, etc.). Other specifics may be entered. For example, the user may request digital deals for baseball games on weeknights. Contact data may include one or more mobile numbers and respective carriers. For example, a user may request the system to contact the user at a first number during the weekends and at a second number during the weeknights. Other specific data may be provided to enable the system to ensure communication with the user when one or more targeted digital deals arise. Profile data and other related data may be stored in Profile Database 142. Also, where server 130 is connected with a system having additional functions, such as a calendar function, then information from this system can supplement user profile data and be considered in determining the issuance of digital deals.

When an excess capacity occasion arises for an event of natural expiration, the client (e.g., provider) may access wireless promotions server 130 and provide input data related to the event to entice potential users to fill up seats and/or use other limited resources (e.g., perishable goods, merchandise, etc.). One or more potential users may then be recognized based on profile data and other data. Other data may include history data related to the user, which may include previous purchases and other related information from other sources. Wireless communication may be used to inform one or more potential users of the targeted digital deals. For example, Server 130 may forward contact data, which may include a mobile phone number and service provider data for each potential user, to Wireless Access Server 150. Wireless Access Server 150 may then convey a text or “short” message to a Wireless Device 170 associated with a user through the user's mobile service provider 160. In another example, a voice portal may be used to convey a voice message to a user.

In keeping with the present invention, the clients 110-112 may include the incentive development and communication capabilities of the wireless promotions server 130, as illustrated by client system 111. For instance, the client 110 may include memory having stored therein incentive templates for generating incentives and may monitor inventory for excess capacity. Upon detecting an over capacity situation for an event, the client 110 may generate an incentive, such as via server 130′, and may issue the incentive to a selected group of potential customers or users, such as via wireless server/provider 150′/160′. In addition, one or more of the databases 140-146 may be maintained, replicated or accessible at the client 111. The client may include a server, such as server 130′, that is in communication with a wireless access server and service provider, such as server/provider 150′/160′. In this manner, the client 110 at system 111 may locally create the incentive, select the group of users, and communicate the incentive directly to the selected group of users as well as monitor the viewing and usage of incentives. This may include two-way communication and exchange of information between the user 114 and client 110. Upon receiving the incentive, the system 111 may permit the user to instantly purchase the item associated with the digital deal. The user may provide information or instructions to effect payment at that time or the system may be able to access pre-registered payment information, such as credit card data, to effect payment.

In one manner of two-way exchange, the user may communicate the user's phone and/or other contact information, wireless access provider information, deal identifier information, redemption information, etc., directly to the client. Also, a digital deal may be displayed via a billboard, kiosk, on-site retail display or advertisement, etc., and may consist of or include a simple deal code. In this scenario, there may be no defined user group pre-selected and the user simply accesses the digital deal by communicating the deal code either through a voice portal or text portal via the user's wireless device. The client or central server may or may not require the user to provide some user profile information in exchange for providing the deal to the user for redemption upon purchasing the associated good or service. The user may communicate the digital deal code and receive the incentive from the server 130 via text or short messaging services.

In the alternative a separate central server 130 may perform the majority of the functions of the system 100. The users 114 may input profile and/or registration data directly to the client via client server 130′ or to a separate service provider, such as at server 130 via the Internet 120. The client may access incentive templates at a central server 130 via Internet 120 and input incentive data, such as via active fields presented by the templates. Rather than monitoring event status and the occurrence of an over-capacity situation at the client and communicating such information to the central server, the central server may have direct access to such information and may process data to arrive at a determination of over-capacity independent of the client. In addition, the client may provide preferred user selection data for use in determining the selection of the group of users. From the incentive template data and user selection data, the central server 130 generates the incentive, selects the user group to receive the incentive offering and transmits the incentive to the selected group of users. Other configurations are fully contemplated by the present invention.

According to another embodiment of the present invention, each digital deal may include a tracking mechanism to enable Server 130 to ensure delivery of the digital deals and/or confirm views. Each digital deal may be assigned a unique deal identifier or authorization code, e.g., a bar code. The retailer or vendor may then examine and verify the encoded deal code when presented on screen, in a printout, verbally or through a bar code scan. The vendor may possess locally a list of valid code or other confirming data or may communicate with a central server or the like to access or present confirming information. Such information may be stored in Tracking Database 144. One or more of the client and/or a service provider may receive information representing the redemption history of the incentive. This information may be used by one or both of the client and the central server in determining future incentive decisions. The system of the present invention may further include report generating capabilities, whereby a client may generate a report tabulating or analyzing data representative of incentive views, redemptions, sales, etc.

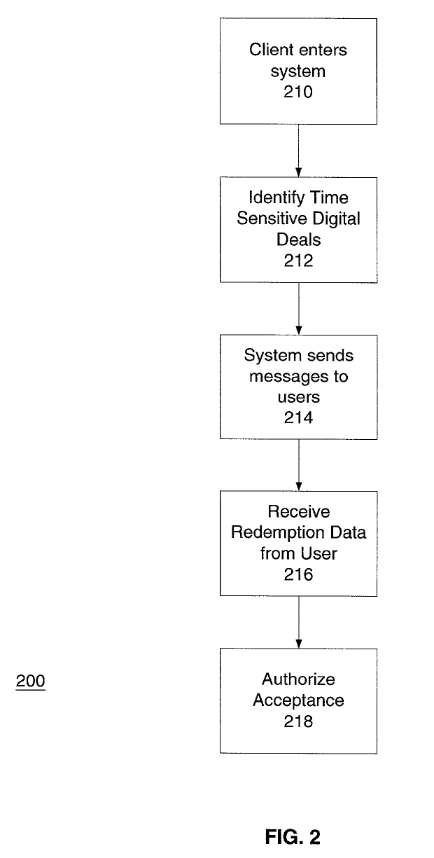

FIGS. 2-4 are flowcharts representing various functions associated with the systems and to methods of the present invention and illustrate the functionality of the system configurations described hereinabove. FIG. 2 is a flowchart illustrating a method for enabling a client to manage excess capacity 200, according to one embodiment of the present invention. A client may enter the system of the present invention at 210, via the Internet or other network or mode of communication. The client may identify specifics of a time sensitive digital deal, at step 212. Specifics may include one or more of resource data, price data, time data, restriction data, location data, instructions data and other information. At step 214, the system may send text, voice or other messages to one or more potential users based on profile data and other relevant data via wireless communication or other selected mode of communication. At step 216, the system may receive redemption data from a user. Redemption data may include a code or other authorization identifier presented at the point-of-sale by the user. Redemption data may further include tracking data associated with the digital deal conveyed to the potential user. In addition, the user may simply display a digital deal on a screen of the user's wireless device. The system (or the client through the system) may authorize the transaction, at step 218. At this step, the provider may reimburse the point-of-sale entity for the digital deal or some form of verification may be required.

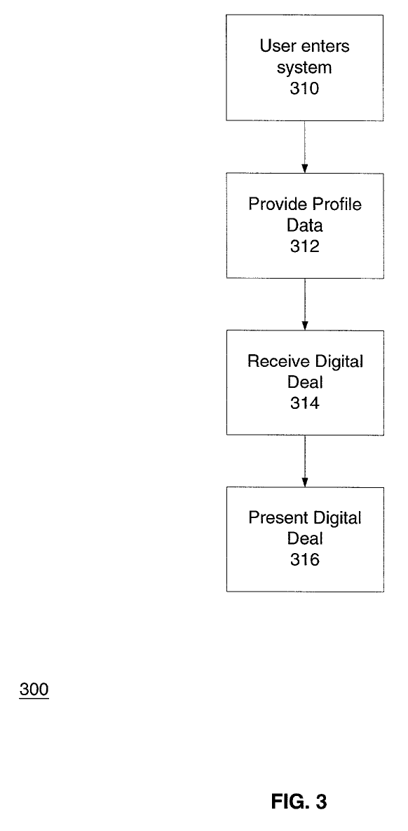

FIG. 3 is a flowchart illustrating a method enabling a user to receive time sensitive digital deals 300, according to another embodiment of the present invention. Users enter the system at step 310 and provide profile data and other relevant data at step 312. At step 314, users receive a digital deal via wireless communication on each selected user's wireless device, such as a cell phone. At redemption step 316, the user presents the digital deal at the point-of-sale or reserve (or purchase) the digital deal via the user's wireless device.

According to an embodiment of the present invention, a user may show a retailer (or other point-of-sale entity) a visual display on the user's wireless device (e.g., screen of a cell phone). The visual display may include a code or other identifier authorizing the user to a discount, as identified by the digital deal, on an event of natural expiration. According to another example, the visual display may include an electronic coupon (or other incentive) and/or the logo of the client or service provider or retail facility. In addition, a wireless link, such as via infrared transmission, may automatically convey the electronic coupon displayed on the wireless device to a checkout station of a retailer. Thus, the coupon information may be stored in a wireless device for transmission to a checkout station. As a result, a paper printout of an electronic coupon is not required thereby simplifying the redemption process for digital deal users.

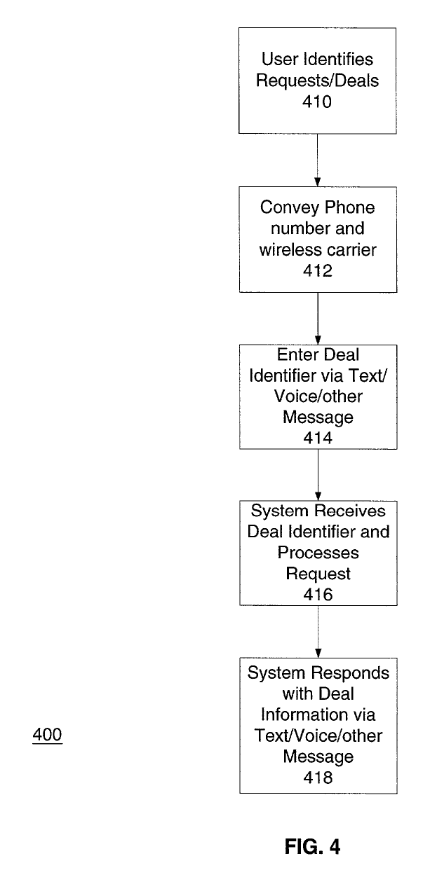

FIG. 4 is a flowchart illustrating a method enabling a user to engage in two-way messaging for digital deals 400, according to an embodiment of the present invention. A user sends a text message via wireless communication to a server to receive a deal on the spot. In return for the message, the system may respond with the relevant deal. At step 410, a user may identify a digital deal or request for digital deal information. At step 412, the user may convey contact data, which may include wireless phone number and wireless carrier information. At step 414, the user may enter a digital deal identifier via a text message over wireless communication to the system of the present invention. At 416, the system may receive the contact data, deal identifier and other data and process the user's request. At step 418, the system may respond with deal information via a text message over wireless communication.

For example, a user may be prompted by an advertisement for a particular product or service. Advertisements may be visually or aurally communicated on billboards, commercials, advertisements, print media, magazines, newspapers, radio, television, and other modes of mass communication. For example, as a user is driving along a road, the user may view a billboard for designer suits on sale. The interested user may dial into the system of the present invention using the user's wireless device. Other modes of communication may be implemented. The user may automatically or manually convey contact data, which may include the user's mobile phone number and wireless carrier. Other information may be conveyed as well. According to an embodiment of the present invention, the user's contact data may be retrieved from the user's profile. According to another embodiment of the present invention, the user may automatically or manually convey the user's contact data on the fly. Thus, the user may not be required to be a pre-registered user of the system to engage in the two-way messaging feature of the present invention. The user may be invited to subsequently register with the system to receive one-way text features of the present invention, as illustrated in FIG. 3.

The user enters a code or other identifier associated with the advertisement of interest as a text message via wireless communication to the system of the present invention. In the alternative, a user may call into the system of the present invention to register and request deals verbally, such as via a voice recognition system. For example, the billboard advertisement for designer suits displays a code for a digital deal. An interested user, via text messaging or verbal expression, communicates the digital deal identifier to the incentive deal management system, which receives the user and deal data and responds to the user with the requested digital deal information via a text message or a speech generating system over wireless communication to the user based on the conveyed contact data. The system may send a visual display which may then be shown to a retailer at the point-of-sale. An electronic purchase using the digital deal may also be accomplished through the wireless device.

According to another embodiment of the present invention, a voice server may be used to convey digital deals to users via a voice message. Similarly, a user may convey digital deal inquiries, acceptances and/or other correspondences via a voice message.

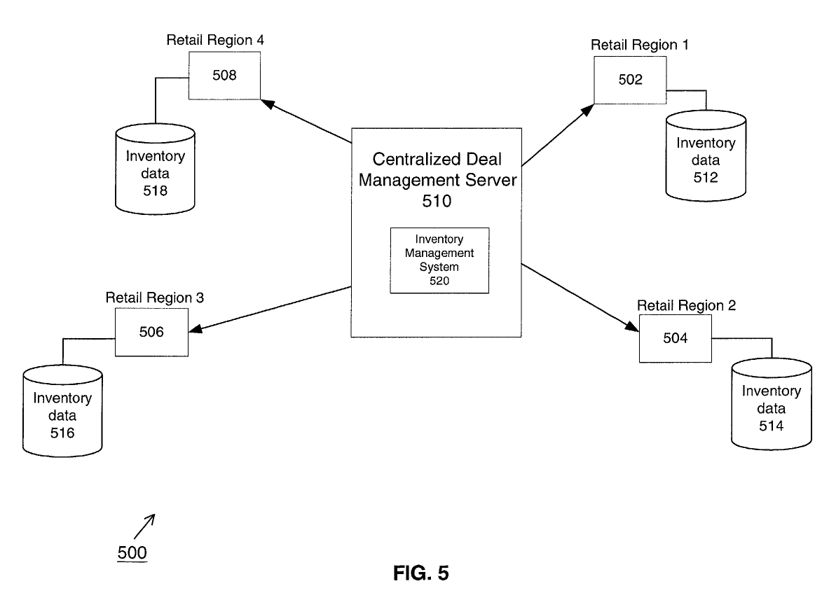

FIG. 5 is a schematic diagram of a centralized deal management system 500, according to an embodiment of the present invention. Centralized deal management server 510 may generate, track and manage digital deals for one or more retail regions for a client. This may be accomplished by geographic demarcation or any other method of segregating retail facilities to accomplish a desired result. As illustrated in FIG. 5, a client may serve one or more retail regions, as shown by retail region 1, 502; retail region 2, 504; retail region 3, 506; and retail region 4, 508. Inventory data and other data may be stored at local databases, as shown by 512, 514, 516, and 518, or may be centrally stored and accessed. A client may have more or less retail regions. Centralized deal management server 510 may identify groups of potential users based on geographic data, availability of resources (e.g., merchandise, goods, etc.) at each region, user profile data, demographic data, population density data and other relevant information. For example, a different number of digital deals of differing type may be offered to a retail region of a highly populated city as compared to that of a small suburb town. For example, the system may generate 2000 digital deals at a retail store (or region) in New York City and provide 200 digital deals at a retail store (or region) in a small town in the Midwest.

As illustrated, centralized deal management server 510 may identify four separate groups of potential users for each retail region, 502, 504, 506 and 508. The digital deals generated for each group may vary depending on various factors, such as demographic data, inventory data, sales data, tracking data and other relevant data. Centralized deal management server 510 may also implement a system to address over-capacity issues. For example, as digital deals are being redeemed at each retail region, a particular retail region may satisfy that region's over capacity issue. The system may then terminate the generation of digital deals for that region and concentrate on the remaining regions. In another example, a greater incentive may be provided to potential users of the remaining regions.

The centralized deal management server may further implement an inventory management system 520 to enable clients to track and regulate digital deals that have been sent and redeemed. Other operations associated with digital deals may also be tracked. This feature of the present invention provides for an automated system for generating digital deals based on real-time sales and/or other data. For example, the inventory management system may send and retrieve data from one or more designated cash registers or other data storage devices, at various locations associated with a client. When sales meet a predetermined level, a predetermined (or appropriate) number of digital deals may be automatically generated for potential users. In addition, after a predetermined number of digital deals have been redeemed, the inventory management system may automatically terminate or alter the parameters, such as the value, of successive digital deals.

The inventory management system may track the sales data for individual items for the generation of specific digital deals. For example, the system may identify that men's ties are experiencing low sales. The system may then generate digital deals for a predetermined (or progressive) incentive amount for the items that are experiencing low sales (e.g., ½ off men's ties, etc.). Sales data may be further tracked by brand, model and other criteria. For example, the system may indicate a particular brand of products at a low sales level. For example, this data may be used to generate incentives to clear out a low selling brand of products.

Other factors may be tracked for inventory based on location (e.g., retail region, city, overall, country, etc.) and/or other factors. In another example, the system may track general sales data for the generation of store-wide or department specific digital deals (e.g., 20% off any item in the entire store, 30% off women's shoes, etc.). Thus, inventory and corresponding digital deals may be tracked based on varying levels of sales data. Restrictions and/or conditions may be applied.

The present invention has been largely described herein as involving events or subjects of natural expiration with limited or finite resources, including, by way of example and not limitation, availability at retail facilities, such as bars and restaurants, concerts, movies, theaters, sporting events, flights, cruises, other time sensitive events, etc. In addition, goods or services potentially offered by the digital deal generating and issuing system of the present invention includes goods or services associated with restaurants, bars, amusement parks, concession stands, car and other rentals, hotels, groceries and other providers. In addition, the retail industry may facilitate sales of merchandise, such as over-stocked goods and end of the season sales, through the present invention. Other service and/or product providers in various industries and sectors may use the system and method of the present invention to reduce excess capacity and resources.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for reducing excess capacity for an event, the event having a predetermined capacity and a natural expiration, the method comprising the steps of:
identifying an event that is likely to have excess capacity at the time of expiration;
creating a digital deal relating to the event to stimulate demand for the event and reduce excess capacity;
communicating the digital deal to one or more consumers via wireless communication; and
enabling the one or more users to partake in the digital deal without generating a printed coupon.

2. The method of claim 1 further comprising the step of communicating the digital deal to a wireless promotions server system prior to communicating the digital deal to a consumer, and wherein the step of communicating the digital deal to the consumer is performed by the wireless promotions server system.

3. The method of claim 1 wherein the step of creating a digital deal comprises using a stored template, the template comprising a plurality of fields, the step of creating a digital deal further comprises entering values for the fields.

4. The method of claim 2 wherein the consumer is a registered user of the wireless promotions server system.

5. The method of claim 1 wherein the wireless communication comprises a text message.

6. The method of claim 1 wherein the wireless communication comprises a voice message.

7. The method of claim 2 wherein the event comprises an entertainment event and the predetermined capacity comprises a limited number of available seats.

8. The method of claim 2 wherein the event comprises an entertainment event and the natural expiration substantially coincides with the performance of the event.

9. The method of claim 2 wherein the step of communicating the time sensitive digital deal comprises the step of conveying a visual display wherein the visual display authorizes the user to receive the digital deal.

10. The method of claim 1 further comprising a step of identifying the consumer's wireless device address information and wireless service provider and referencing a digital deal code associated with the digital deal.

11. A method for enabling digital deals via wireless devices, the method comprising the steps of:
creating a digital deal;
displaying information regarding the existence of the deal and contact information regarding the deal;
a consumer creating a first text message via a wireless device and sending the text message to a system associated with the contact information;
at the system, receiving the text message, processing the message and sending a second text message back to the consumer's wireless device with information about how to partake in the digital deal; and
the consumer using the second text message to partake in the digital deal without generating a printed coupon.

12. The method of claim 11 wherein the step of a consumer creating a text message comprises the steps of a consumer identifying the consumer's wireless device address information and wireless service provider and referencing a digital deal code associated with the displayed information.

13. A system for enabling a client to reduce excess capacity via wireless devices, the system comprising:
a wireless promotions server system;
means for creating digital deals and transmitting the digital deal information to the wireless promotions server system; and
wireless communication means for communicating the digital deal from the wireless promotions server system to one or more consumers via wireless communication to enable the consumer to partake in the digital deal without generating a printed coupon.

14. The system of claim 13 wherein the wireless communication comprises a text message.

15. The system of claim 13 wherein the digital deal relates to an event, the event having a predetermined capacity and a natural expiration.

16. The system of claim 13 wherein the communication means comprises a conveying means for conveying a visual display wherein the visual display authorizes the user to receive the digital deal.

17. The system of claim 13, further comprising:
means for receiving profile data associated with a user.

18. The system of claim 17, further comprising means, responsive to the wireless promotions server system, receiving one or more digital deals, for comparing deal information with user profile data and selectively transmitting the digital deal to one or more consumers based on their profile data.

19. The system of claim 17 wherein the means for receiving receives profile data from a consumer via a wireless communication.

20. The system of claim 12 further comprising means for identifying the consumer's wireless device address information and wireless service provider and referencing a digital deal code associated with the digital deal.
